(19) United States
(12) Patent Application Publication
(10) Pub. No.: US 2025/0253723 A1
(43) Pub. Date: Aug. 7, 2025

(54) MOTOR

(71) Applicant: TOYOTA JIDOSHA KABUSHIKI KAISHA, Toyota-shi (JP)

(72) Inventors: Kengo OHIRA, Toyota-shi (JP); Kenichiro HAYASHI, Ohbu-shi (JP); Tatsuya SAKAI, Toyota-shi (JP)

(73) Assignee: TOYOTA JIDOSHA KABUSHIKI KAISHA, Toyota-shi (JP)

(21) Appl. No.: 18/940,857

(22) Filed: Nov. 8, 2024

(30) Foreign Application Priority Data
Feb. 5, 2024 (JP) 2024-015957

(51) Int. Cl. H02K 1/20; H02K 5/10

(52) U.S. Cl. CPC H02K 1/20; H02K 5/10

(57) ABSTRACT

In the motor, the stator core has a main body portion having a ridge extending along an axial direction parallel to the motor axis on an outer peripheral surface thereof, and an extending portion arranged to protrude in the axial direction from an end surface of the ridge. The case has an accommodating hole extending along the motor shaft and into which the extending portion is inserted, and a seat surface disposed around the accommodating hole and to which the ridge is fixed. The guide ring is disposed in the accommodating hole and has a ring shape concentric with the motor shaft. An annular cooling liquid flow path is configured of a space surrounded by an end surface of the extending portion in the axial direction, the case, and an outer peripheral surface of the guide ring. a sealing portion is provided between the extending portion and the case.

### CROSS-REFERENCE TO RELATED APPLICATION

This application claims priority to Japanese Patent Application No. 2024-015957 filed on Feb. 5, 2024, incorporated herein by reference in its entirety.

### BACKGROUND

### 1. Technical Field

The technique disclosed in the present specification relates to a motor.

### 2. Description of Related Art

A motor disclosed in Japanese Unexamined Patent Application Publication No. 2017-204980 (JP 2017-204980 A) includes a stator core, a case, and a guide ring. The stator core and the guide ring are accommodated in a cylindrical case. The guide ring is disposed concentrically with the stator core and is in contact with the stator core and the case. An annular cooling liquid flow path is configured of a space surrounded by the stator core, the guide ring, and the case. The motor is cooled by a cooling liquid (oil, for example) being supplied from the annular cooling liquid flow path to each component inside the case.

### SUMMARY

A ridge for fixation may be provided on an outer peripheral surface of the stator core. The stator core can be fixed to the case by fixing the ridge to the case with a bolt and the like. On the other hand, when a ridge is present on the outer peripheral surface of the stator core, it is difficult to bring the outer peripheral surface of the stator core into close contact with the case. When a gap is present between the stator core and the case, the cooling liquid in the annular cooling liquid flow path leaks through the gap, and it becomes difficult to cause the cooling liquid to flow to the annular cooling liquid flow path at an appropriate flow rate. In the present specification, a technique of suppressing leakage of a cooling liquid from an annular cooling liquid flow path in a motor in which a ridge is provided on an outer peripheral surface of a stator core is proposed.

A motor disclosed in the present specification includes: a stator core; a case; and a guide ring. The stator core includes a main body portion and an extending portion. The main body portion has a cylindrical shape that is concentric with a motor shaft and has, on an outer peripheral surface, a ridge extending in an axial direction that is parallel to the motor shaft.

The extending portion has a cylindrical shape that is concentric with the motor shaft and is disposed to project in the axial direction from an end surface of the ridge.

The case includes an accommodating hole and a seat surface.

The accommodating hole extends along the motor shaft, and the extending portion is inserted into the accommodating hole.

The seat surface is disposed around the accommodating hole and is in contact with the end surface of the ridge, and the ridge is fixed to the seat surface.

The guide ring is disposed in the accommodating hole and has a ring shape that is concentric with the motor shaft.

An annular cooling liquid flow path is configured of a space surrounded by an end surface of the extending portion in the axial direction, the case, and an outer peripheral surface of the guide ring.

A sealing portion is provided between the extending portion and the case.

In the motor, the stator core includes the extending portion that projects in the axial direction relative to the end surface of the ridge. It is possible to effectively suppress leakage of a cooling liquid from the annular cooling liquid flow path by providing the sealing portion between the extending portion which is not provided with the ridge and the case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view of a motor;

FIG. 2 is a view showing a cross section of the case along the motor shaft and an internal structure of the case 50;

FIG. 3 is a perspective view of a stator core;

FIG. 4 is a plan view of the stator as viewed along the motor axis;

FIG. 5 is a cross-sectional view of the case along the motor axis;

FIG. 6 is an enlarged cross-sectional view of the motor of Example 1;

FIG. 7 is an enlarged cross-sectional view of a motor according to a second embodiment; and

FIG. 8 is an enlarged cross-sectional view of a motor according to a modification of the second embodiment.

### DETAILED DESCRIPTION OF EMBODIMENTS

In an example motor disclosed in the present specification, the accommodating hole may have a first part, a second part, and a stepped surface. The extending portion may be inserted into the first part. The second part may be adjacent to the first part in the axial direction and may be smaller in diameter than the first part to accommodate the guide ring. The stepped surface may connect an inner peripheral surface of the first part and an inner peripheral surface of the second part. The end surface of the extending portion may be in contact with the stepped surface. The sealing portion may be formed by a contact region between the end surface of the extending portion and the stepped surface.

By bringing the end surface of the extending portion and the stepped surface into contact with each other, these interfaces can be sealed without gaps.

In the motor of the example disclosed in the present specification, the stepped surface may be a cutting surface.

According to this configuration, the end surface of the extending portion can be brought into closer contact with the stepped surface, and the leakage of the cooling liquid can be suppressed more effectively.

In the motor of the example disclosed in the present specification, the sealing portion may be formed by a sealing member provided between an outer peripheral surface of the extending portion and the inner peripheral surface of the accommodating hole.

According to this configuration, since both the outer peripheral surface of the extending portion and the inner peripheral surface of the accommodating hole can be a cylindrical surface (i.e., a cylindrical curved surface), by providing a sealing member between them, it is possible to seal these interfaces without gaps.

In the motor of the example disclosed in this specification, a groove may be provided on the outer peripheral surface of the extending portion. The sealing member may be disposed in the groove.

In the motor of the example disclosed in the present specification, the inner peripheral surface of the accommodating hole in a range in contact with the sealing member may be a cutting surface.

According to this configuration, the sealing member can be brought into close contact with the inner peripheral surface of the accommodating hole, and leakage of the cooling liquid can be suppressed more effectively.

In the motor of the example disclosed in the present specification, the case may have a facing portion facing the end surface of the extending portion. The guide ring may be sandwiched and fixed between the end surface of the extending portion and the facing portion.

According to this configuration, the guide ring can be fixed by stacking the guide ring and the stator core in the axial direction.

In the motor of the example disclosed in the present specification, an in-core cooling liquid flow path through which the cooling liquid supplied from the annular cooling liquid flow path flows may be provided inside the stator core.

In an example motor disclosed in the present specification, a coil end may be disposed on an inner peripheral side of the guide ring, and a cooling liquid discharge flow path may be provided in the guide ring to penetrate the guide ring in a radial direction.

### Example 1

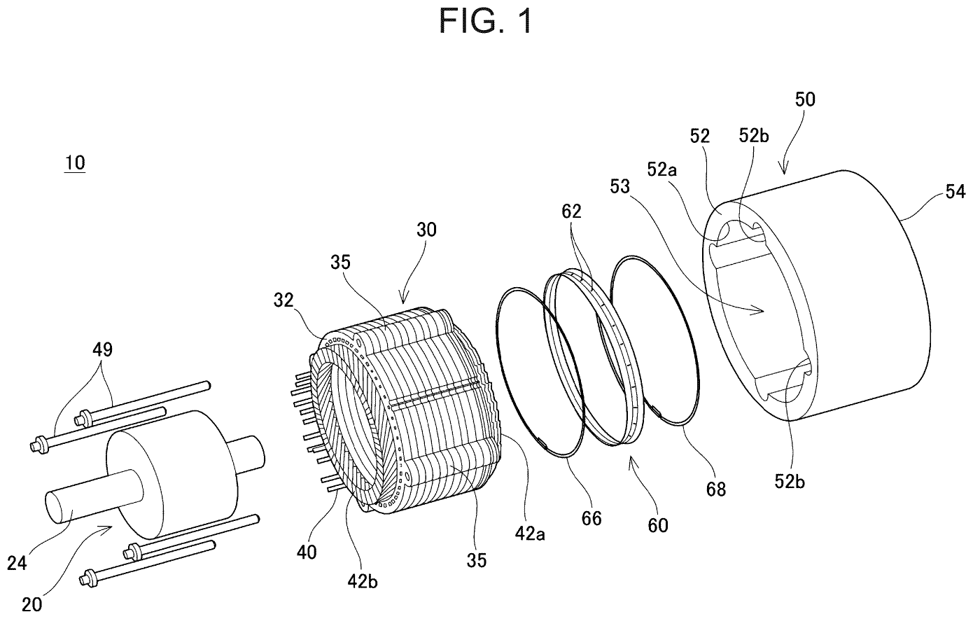

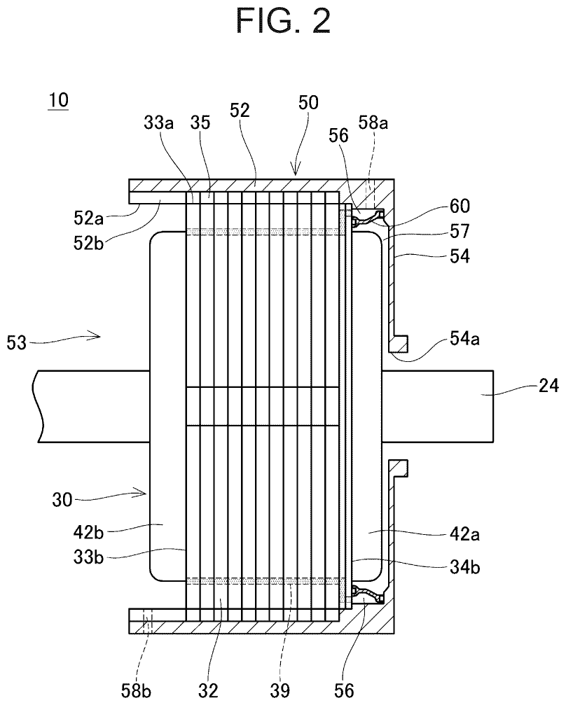

The motor 10 of the first embodiment shown in FIGS. 1 and 2 includes a rotor 20, a stator 30, and a case 50. The rotor 20 includes a shaft 24. The stator 30 has a cylindrical shape. The rotor 20 is disposed in the center hole of the stator 30 so that the center axis of the shaft 24 and the center axis of the stator 30 coincide with each other. The rotor 20 and the stator 30 are housed in the case 50. Hereinafter, a direction parallel to the motor axis (that is, the central axis of the shaft 24) is referred to as an axial direction, a direction along the radius of a circle around the motor axis is referred to as a radial direction, and a direction along the circle is referred to as a circumferential direction.

The stator 30 includes a stator core 32 and a coil 40. In FIG. 2, the coil ends 42a, 42b of the coil 40 are illustrated in a simplified manner. The coil 40 is wound around a stator core 32 (more specifically, a tooth 36 to be described later).

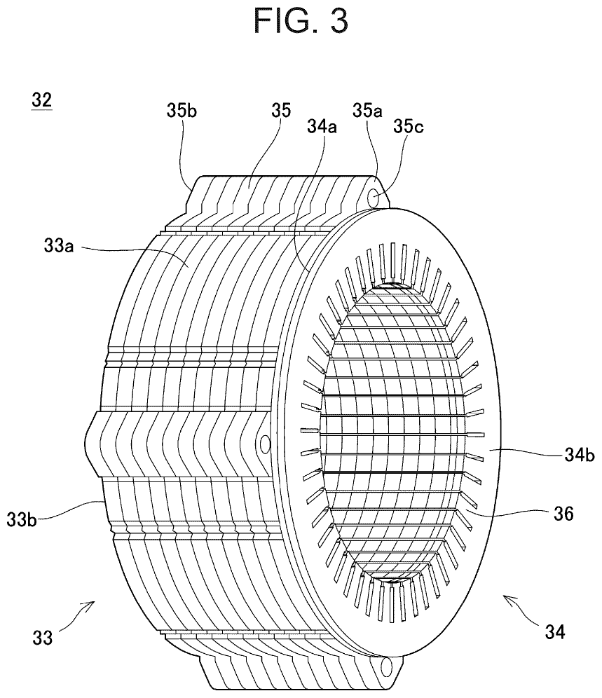

As shown in FIG. 3, the stator core 32 is composed of a plurality of electromagnetic steel sheets stacked in the axial direction. The stator core 32 includes a main body portion 33 and an extending portion 34 provided so as to be axially adjacent to the main body portion 33. Each of the main body portion 33 and the extending portion 34 has a cylindrical shape concentric with the motor shaft. The main body portion 33 is a portion in which a plurality of ridges 35 are provided on the outer peripheral surface, and the extending portion 34 is a portion in which the ridges 35 are not provided on the outer peripheral surface. The outer peripheral surface of the main body portion 33 has a cylindrical surface 33a concentric with the motor shaft, and a plurality of ridges 35 protruding from the cylindrical surface 33a. Each ridge 35 extends along the axial direction. The plurality of ridges 35 are arranged at intervals in the circumferential direction. The outer peripheral surface of the 15 extending portion 34 is configured by a cylindrical surface 34a concentric with the motor shaft. The diameter of the cylindrical surface 33a is equal to the diameter of the cylindrical surface 34a. The extending portion 34 protrudes axially from one end surface 35a of the ridges 35. The ridges 35 are provided with bolt-fastening holes 35c extending along the axial direction. The bolt-fastening hole 35c extends from one end surface 35a of the ridge 35 to the other end surface 35b. 20

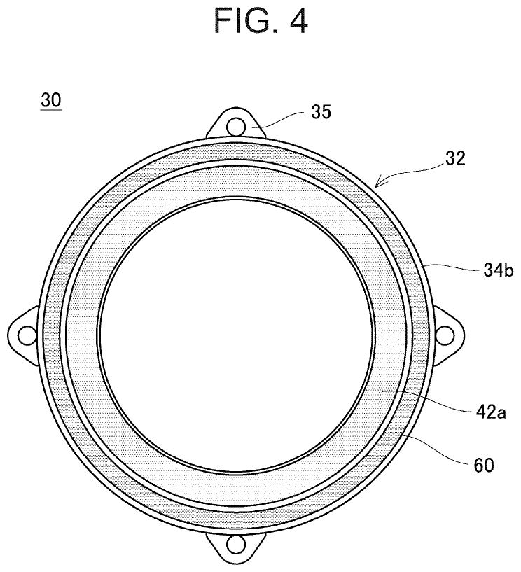

The stator core 32 has a plurality of teeth 36 on its inner peripheral surface. Each tooth 36 protrudes radially inward from the inner peripheral surface of the stator core 32. Each tooth 36 extends along the axial direction. The teeth 36 extend from one end surface of the stator core 32 (i.e., the end surface 34b of the extending portion 34) to the other end 25 surface (i.e., the end surface 33b of the main body portion 33). The plurality of teeth 36 are arranged at intervals in the circumferential direction. The coil 40 is wound around the teeth 36. As shown in FIG. 2, the end surface 34b is provided with a coil end 42a. The end surface 33b is provided with a coil end 42b. The coil ends 42a, 42b are a bent part of the coil 40 wound around the stator core 32. The coil end 42a protrudes from the end surface 34b, and 30 the coil end 42b protrudes from the end surface 33b. As shown in FIG. 4, the coil end 42a are annularly distributed in the end surface 34b. Similarly, the coil end 42b is annularly distributed in the end surface 33b.

As illustrated in FIGS. 1 and 2, the case 50 includes an outer peripheral wall 52 and a partition wall 54. The outer peripheral wall 52 has a cylindrical shape. The partition wall 54 is provided at one end portion of the outer peripheral wall 52 in the axial direction. A through-hole 54a is provided at the center of the partition wall 54. The rotor 20 and the stator 30 are accommodated in a space 53 inside the outer peripheral wall 52.

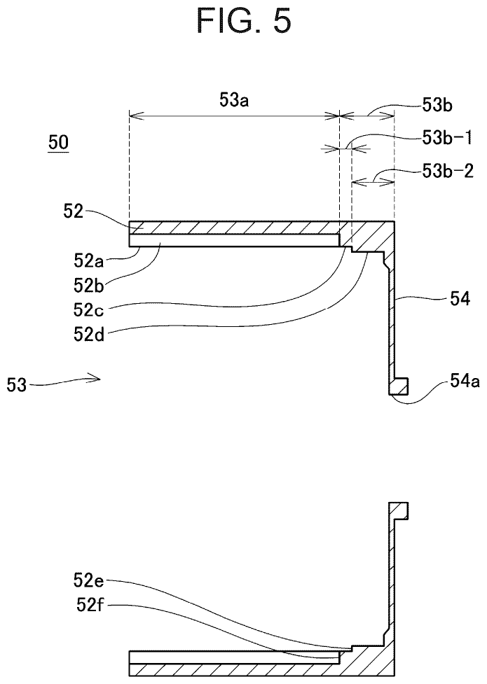

As shown in FIG. 5, the space 53 has a main body housing portion 53a and an accommodating hole 53b extending from the main body housing portion 53a toward the back (that is, toward the partition wall 54). As shown in FIGS. 1 and 5, within the scope of the main body housing portion 53a, the inner peripheral surface of the outer peripheral wall 52 has a cylindrical surface 52a and a plurality of groove 52b. The cylindrical surface 52a is provided concentrically with the motor shaft. The respective grooves 52b are provided in the cylindrical surface 52a and extend along the axial direction. The plurality of grooves 52b is circumferentially spaced apart.

The accommodating hole 53b has a first part 53b-1 and a second part 53b-2. The first part 53b-1 extends from the main body housing portion 53a toward the back, and the second part 53b-2 extends from the first part 53b-1 toward the back.

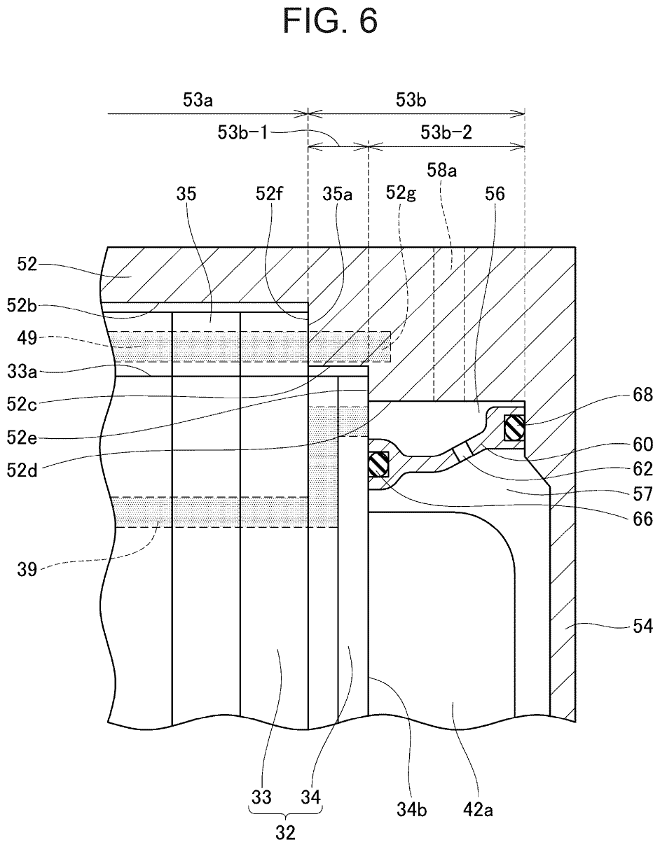

The inner circumferential surface of the first part 53b-1 is constituted by a cylindrical surface 52c. The cylindrical surface 52c is provided concentrically with the motor shaft. The diameter of the cylindrical surface 52c is equal to the diameter of the cylindrical surface 52a. The diameter of the cylindrical surface 52c is larger than the diameter of the extending portion 34 of the stator core 32. Within the first part 53b-1, the groove 52b is not provided on the inner peripheral surface of the outer peripheral wall 52. Therefore, the end surface of the groove 52b is located at the border between the main body housing portion 53a and the first part 53b-1. The end surface of the groove 52b is a seat surface 52f to which the stator core 32 is attached. The seat surfaces 52f of the respective groove 52b are arranged around the accommodating hole 53b. The seat surface 52f is a cutting surface formed by cutting. As shown in FIG. 6, the seat surface 52f is provided with a screw-hole 52g.

As shown in FIG. 5, the inner peripheral surface of the second part 53b-2 is constituted by a cylindrical surface 52d. The cylindrical surface 52d is provided concentrically with the motor shaft. The diameter of the cylindrical surface 52d is smaller than the diameter of the extending portion 34 of the stator core 32. The diameter of the cylindrical surface 52d is smaller than the diameter of the cylindrical surface 52c. Therefore, a stepped surface 52e is formed at the interface between the second part 53b-2 and the first part 53b-1. The stepped surface 52e is a plane extending along the radial direction and the circumferential direction. The stepped surface 52e is provided over the entire circumferential area. The stepped surface 52e connects the cylindrical surface 52c and the cylindrical surface 52d. The stepped surface 52e is a cutting surface formed by cutting.

As shown in FIG. 6, the stator core 32 is accommodated in the case 50 such that the ridges 35 are located in the corresponding groove 52b. The end surface 35a of the ridges 35 are in contact with the seat surface 52f. A bolt 49 (see FIG. 1) is inserted into a bolt fastening hole 35c (see FIG. 3) of each ridge 35. As shown in FIG. 6, the bolt 49 is fastened to a screw-hole 52g provided on the seat surface 52f. As a result, the ridges 35 are fixed to the seat surface 52f. That is, the stator 30 is fixed to the case 50. The extending portion 34 of the stator core 32 is inserted into the first part 53b-1 of the accommodating hole 53b. The end surface 34b of the extending portion 34 is in contact with the stepped surface 52e at the outer peripheral portion. The end surface 34b of the extending portion 34 faces the partition wall 54. The partition wall 54 is an example of a facing portion. A gap is provided between the partition wall 54 and the end surface 34b of the extending portion 34, and a coil end 42a is disposed in the gap.

The rotor 20 is housed in the case 50 in a state of being concentric with the stator core 32. As shown in FIG. 2, the shaft 24 of the rotor 20 is inserted into the through-hole 54a of the case 50. The rotor 20 is rotatably supported by a bearing or the like in the case 50.

As shown in FIGS. 1 and 2, the motor 10 includes a guide ring 60. The guide ring 60 has a ring shape. As shown in FIG. 6, the guide ring 60 is disposed in the second part 53b-2 of the accommodating hole 53b. The guide ring 60 is arranged to extend annularly around the motor shaft (i.e., shaft 24). The guide ring 60 is disposed concentrically with the motor shaft, and is sandwiched and fixed between the end surface 34b of the extending portion 34 and the partition wall 54. A coil end 42a is disposed radially inward of the guide ring 60. The guide ring 60 partitions a space between the stator core 32 and the partition wall 54 into a space 56 on the outer peripheral side and a space 57 on the inner peripheral side. The space 56 on the outer peripheral side is a space surrounded by the inner surface of the case 50, the outer peripheral surface of the guide ring 60, and the end surface 34b of the extending portion 34, and has an annular shape. Hereinafter, the space 56 on the outer peripheral side is referred to as an annular cooling liquid flow path 56.

One end of the guide ring 60 is in contact with the end surface 34b of the extending portion 34, and the other end of the guide ring 60 is in contact with the partition wall 54. A sealing member 66 is provided at an interface between the guide ring 60 and the stator core 32. The sealing member 66 seals the interface between the guide ring 60 and the stator core 32. A sealing member 68 is provided at the interface between the guide ring 60 and the partition wall 54. The sealing member 68 seals the interface between the guide ring 60 and the partition wall 54.

The case 50 is provided with a cooling liquid supply path 58a. The cooling liquid supply path 58a connects the outside of the case 50 and the annular cooling liquid flow path 56. As shown in FIG. 2, a cooling liquid discharge path 58b is provided in a lower portion of the case 50. The cooling liquid discharge path 58b connects the inside and the outside of the case 50. The cooling liquid discharge path 58b is connected to the cooling liquid supply path 58a via a circulation passage (not shown) provided outside the case 50. A pump (not shown) is provided in the circulation flow path. A cooling liquid is stored in the case 50. When the pump is operated, the coolant in the case 50 is supplied to the annular cooling liquid flow path 56 via the cooling liquid discharge path 58b and the cooling liquid supply path 58a. As will be described in detail later, the cooling liquid supplied to the annular cooling liquid flow path 56 is discharged into the case 50. In this way, the cooling liquid circulates through the circulation flow path and the case 50. In the present embodiment, the cooling liquid is cooling oil. The cooling oil functions as a cooling liquid for cooling the motor 10 and also functions as a lubricating oil for lubricating the rotor 20.

As shown in FIG. 1, the guide ring 60 is provided with a plurality of cooling liquid discharge flow paths 62. The guide ring 60 is provided with a plurality of cooling liquid discharge flow paths 62 distributed in the circumferential direction. As shown in FIG. 6, each of the cooling liquid discharge flow paths 62 penetrates the guide ring 60 in the radial direction. The annular cooling liquid flow path 56 and the space 57 (that is, the space in which the coil end 42a is present) are connected by the cooling liquid discharge flow path 62. The cooling liquid discharge flow paths 62 discharge the coolant in the annular cooling liquid flow path 56 toward the coil end 42a.

As shown in FIG. 2, a plurality of in-core cooling liquid flow paths 39 are provided inside the stator core 32. Each of the in-core cooling liquid flow paths 39 extends along the axial direction. One end of the in-core cooling liquid flow path 39 is open to the end surface 34b, and is connected to the annular cooling liquid flow path 56. The other end of the in-core cooling liquid flow path 39 is open to the end surface 33b. The plurality of in-core cooling liquid flow paths 39 are provided so as to be dispersed in the circumferential direction.

During the operation of the motor 10, the cooling liquid is supplied from the cooling liquid supply path 58a to the annular cooling liquid flow path 56. The coolant in the annular cooling liquid flow path 56 flows into the cooling liquid discharge flow path 62 and the in-core cooling liquid flow path 39. The coolant in the cooling liquid discharge flow path 62 is discharged toward the coil end 42a. As a result, the coil end 42a is cooled. The coolant discharged toward the coil end 42a flows to the lower portion of the case 50. In addition, the cooling liquid flowing in the in-core cooling liquid flow path 39 cools the stator core 32. The coolant in the in-core cooling liquid flow path 39 is discharged from the end surface 33b into the case 50. The coil end 42b is cooled by the coolant discharged from the end surface 33b. The coolant discharged from the end surface 33b flows to the lower portion of the case 50. The coolant flowing to the lower portion of the case 50 and accumulated in the case 50 is sent from the cooling liquid discharge path 58b to the cooling liquid supply path 58a via an external pump. As described above, the motor 10 is cooled by circulation of the cooling liquid.

As shown in FIG. 6, the interface between the stator core 32 and the case 50 is sealed by the contacting area between the end surface 34b of the extending portion 34 and the stepped surface 52e. Since both the end surface 34b and the stepped surface 52e are flat surfaces, they can be brought into close contact with each other without any gap. In particular, the case 50 is a casting, while the stepped surface 52e is a cutting surface formed by cutting after casting, so that the flatness of the stepped surface 52e is higher. Further, the end surface 34b and the stepped surface 52e are pressed by the fastening of the bolts 49. Therefore, the end surface 34b can be suitably brought into close contact with the stepped surface 52e. This ensures that the contact area is sealed. Therefore, leakage of the coolant in the annular cooling liquid flow path 56 from the interface between the stator core 32 and the case 50 can be effectively suppressed. Therefore, the cooling liquid flows efficiently from the annular cooling liquid flow path 56 to the in-core cooling liquid flow path 39 and the cooling liquid discharge flow path 62, and the motor 10 is cooled efficiently.

Further, as described above, the stepped surface 52e is a cutting surface, and is formed with high accuracy. The seat surface 52f is a cutting surface, and is formed with a high-precision. Therefore, the relative positional accuracy between the stepped surface 52e and the seat surface 52f is high. Therefore, it is possible to prevent a gap from being formed between the end surface 34b of the extending portion 34 and the stepped surface 52e, and to more effectively prevent the coolant from leaking in the contacting area between the end surface 34b and the stepped surface 52e. Further, since the relative positional accuracy between the stepped surface 52e and the seat surface 52f is high, excessive pressure is prevented from being applied to the stepped surface 52e from the end surface 34b, and the reliability of the motor is improved.

### Example 2

In the motor of the second embodiment, the sealing structure at the interface between the stator core 32 and the case 50 is different from that of the first embodiment. The other configuration of the motor of the second embodiment is the same as that of the first embodiment.

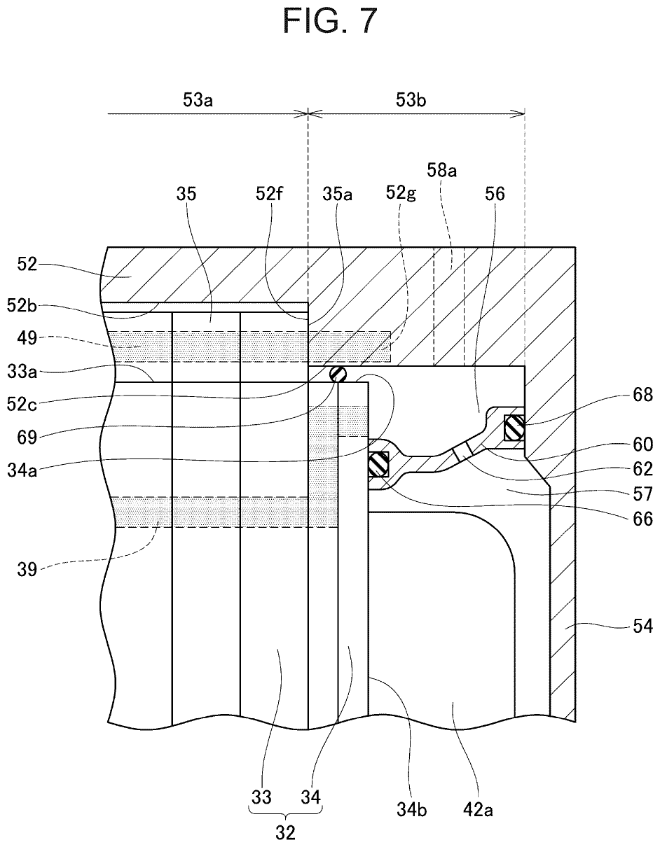

As shown in FIG. 7, in the second embodiment, no step is provided on the inner peripheral surface of the accommodating hole 53b. The entire inner peripheral surface of the accommodating hole 53b is constituted by a cylindrical surface 52c having the same diameter as the cylindrical surface 52a (see FIG. 1). In addition, a sealing member 69 (for example, an O-ring or the like) is provided on an outer peripheral surface (i.e., a cylindrical surface 34a) of the extending portion 34. The sealing member 69 seals the border between the outer peripheral surface of the extending portion 34 and the inner peripheral surface (i.e., the cylindrical surface 52c) of the accommodating hole 53b. Since both the outer peripheral surface of the extending portion 34 and the inner peripheral surface of the accommodating hole 53b are cylindrical surfaces, these interfaces can be suitably sealed by the sealing member 69. In particular, the sealing member 69 can be brought into close contact with the inner peripheral surface of the accommodating hole 53b because the inner peripheral surface of the accommodating hole 53b (i.e., the cylindrical surface 52c) is a cutting surface formed by cutting. Therefore, leakage of the cooling liquid can be suppressed more effectively. Therefore, it is possible to prevent the coolant in the annular cooling liquid flow path 56 from leaking from the interface between the stator core 32 and the case 50. Therefore, the cooling liquid flows efficiently from the annular cooling liquid flow path 56 to the in-core cooling liquid flow path 39 and the cooling liquid discharge flow path 62, and the motor 10 is cooled efficiently.

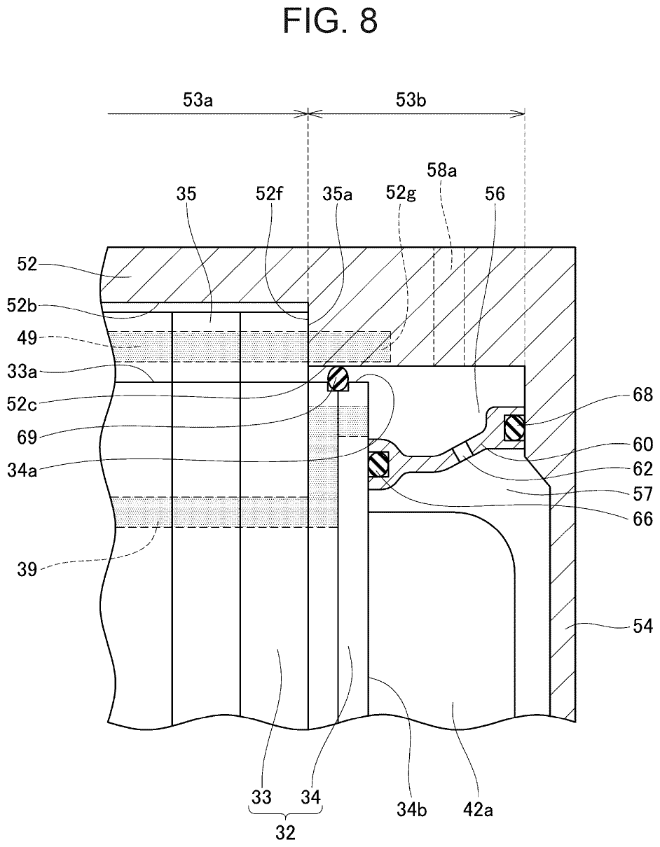

In the second embodiment, as shown in FIG. 8, a groove may be provided on the outer peripheral surface of the extending portion 34, and a sealing member 69 may be provided in the groove. According to this configuration, it is possible to suppress displacement of the sealing member 69 due to the groove.

As described above, in the motors of the first and second embodiments, the sealing portion is provided on the surface of the extending portion 34 instead of the outer peripheral surface of the main body portion 33 having the ridge 35. Therefore, leakage of the cooling liquid in the annular cooling liquid flow path 56 can be suitably suppressed.

In the above-described embodiment, the outer peripheral wall 52 is provided along the outer peripheral surface of the main body portion 33, but a wide distance may be provided between the main body portion 33 and the outer peripheral wall 52.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

What is claimed is:

1. A motor comprising:
a stator core;
a case; and
a guide ring,
wherein the stator core includes
a main body portion that has a cylindrical shape that is concentric with a motor shaft and has, on an outer peripheral surface, a ridge extending in an axial direction that is parallel to the motor shaft, and
an extending portion that has a cylindrical shape that is concentric with the motor shaft and is disposed to project in the axial direction from an end surface of the ridge,
the case includes
an accommodating hole that extends along the motor shaft, the extending portion being inserted into the accommodating hole, and
a seat surface that is disposed around the accommodating hole and is in contact with the end surface of the ridge, the ridge being fixed to the seat surface,
the guide ring is disposed in the accommodating hole and has a ring shape that is concentric with the motor shaft,
an annular cooling liquid flow path is configured of a space surrounded by an end surface of the extending portion in the axial direction, the case, and an outer peripheral surface of the guide ring, and
a sealing portion is provided between the extending portion and the case.

2. The motor according to claim 1, wherein:
the accommodating hole includes
a first part into which the extending portion is inserted,
a second part that is adjacent to the first part in the axial direction, has a smaller diameter than the first part, and accommodates the guide ring, and
a stepped surface that connects an inner peripheral surface of the first part and an inner peripheral surface of the second part, the end surface of the extending portion being in contact with the stepped surface; and
the sealing portion is configured by a contact region between the end surface of the extending portion and the stepped surface.

3. The motor according to claim 2, wherein the stepped surface is a cut surface.

4. The motor according to claim 1, wherein the sealing portion is configured of a sealing member provided between an outer peripheral surface of the extending portion and an inner peripheral surface of the accommodating hole.

5. The motor according to claim 4, wherein:
a groove is provided in the outer peripheral surface of the extending portion; and
the sealing member is disposed in the groove.

6. The motor according to claim 4, wherein the inner peripheral surface of the accommodating hole in a range in contact with the sealing member is a cut surface.

7. The motor according to claim 1, wherein:
the case includes a facing portion that faces the end surface of the extending portion; and
the guide ring is sandwiched and fixed between the end surface of the extending portion and the facing portion.

8. The motor according to claim 1, wherein an in-core cooling liquid flow path through which a cooling liquid supplied from the annular cooling liquid flow path flows is provided inside the stator core.

9. The motor according to claim 1, wherein:
a coil end is disposed on an inner peripheral side of the guide ring; and
the guide ring is provided with a cooling liquid discharge flow path that penetrates through the guide ring in a radial direction.
